(19) United States
(12) Patent Application Publication
(10) Pub. No.: US 2025/0061656 A1
(43) Pub. Date: Feb. 20, 2025

(54) VIRTUAL OBJECT INTERACTION METHOD AND APPARATUS

(71) Applicant: Tencent Technology (Shenzhen) Company Limited, Shenzhen (CN)

(72) Inventors: Siyuan WANG, Shenzhen (CN); Teng CHEN, Shenzhen (CN); Guanjun ZHANG, Shenzhen (CN)

(73) Assignee: Tencent Technology (Shenzhen) Company Limited, Shenzhen, GD (CN)

(21) Appl. No.: 18/937,010

(22) Filed: Nov. 4, 2024

Related U.S. Application Data
(63) Continuation of application No. PCT/CN2023/120932, filed on Sep. 25, 2023.

(30) Foreign Application Priority Data
Nov. 23, 2022 (CN) 202211476949.X

(51) Int. Cl. G06T 17/00; G06T 13/40

(52) U.S. Cl. CPC G06T 17/00; G06T 13/40

(57) ABSTRACT

In a virtual object interaction method, a first virtual object in a target virtual state is displayed in a virtual scene. A target interaction interface is displayed when a first interaction is performed on the first virtual object. The target interaction interface includes at least one interaction option corresponding to the target virtual state. First target interaction information is displayed when a second interaction is performed on a first interaction option of the at least one interaction option. The first target interaction information includes an interaction effect associated with the first interaction option for the first virtual object.

### RELATED APPLICATIONS

The present application is a continuation of International Application No. PCT/CN2023/120932, filed on Sep. 25, 2023, which claims priority to Chinese Patent Application No. 202211476949.X, filed on Nov. 23, 2022. The entire disclosures of the prior applications are hereby incorporated by reference.

### FIELD OF THE TECHNOLOGY

This disclosure relates to the field of computers, including to a virtual object interaction method and apparatus, a storage medium, an electronic device, and a program product.

### BACKGROUND OF THE DISCLOSURE

Currently, in a virtual scene, a general manner for interacting with a virtual object is clicking/tapping on a virtual character to enter a detail page of the virtual character, on which there is a button for interacting with a friend, such as a like button. However, this interaction mode is not combined with a state of the virtual character, and interaction modes for all virtual characters are the same. Therefore, a user has no fresh feeling and cannot obtain effective interaction feedback, resulting in a monotonous interaction effect of the virtual object.

### SUMMARY

Embodiments of this disclosure provide a virtual object interaction method and apparatus, a storage medium, an electronic device, and a program product, to resolve at least a technical problem in related art that users have low willingness to interact with each other because of a monotonous interaction effect of a virtual object.

According to an aspect of this disclosure, a virtual object interaction method is provided. In the method, a first virtual object in a target virtual state is displayed in a virtual scene. A target interaction interface is displayed when a first interaction is performed on the first virtual object. The target interaction interface includes at least one interaction option corresponding to the target virtual state. First target interaction information is displayed when a second interaction is performed on a first interaction option of the at least one interaction option. The first target interaction information includes an interaction effect associated with the first interaction option for the first virtual object.

According to an aspect of this disclosure, an information processing apparatus, such as a virtual object interaction apparatus is further provided. The apparatus includes processing circuitry that is configured to display a first virtual object in a target virtual state in a virtual scene. The processing circuitry is configured to display a target interaction interface when a first interaction is performed on the first virtual object. The target interaction interface includes at least one interaction option corresponding to the target virtual state. The processing circuitry is configured to display first target interaction information when a second interaction is performed on a first interaction option of the at least one interaction option. The first target interaction information includes an interaction effect associated with the first interaction option for the first virtual object.

According to an aspect of this disclosure, a non-transitory computer-readable storage medium is further provided. The non-transitory computer-readable storage medium has a computer program stored thereon, and the computer program, when executed by a processor causes the processor to perform the foregoing virtual object interaction method.

According to an aspect of this disclosure, a computer program product or a computer program is provided. The computer program product or the computer program includes computer instructions, and the computer instructions are stored in a computer-readable storage medium. A processor of a computer device reads the computer instructions from the computer-readable storage medium, and executes the computer instructions, to enable the computer device to perform the foregoing virtual object interaction method.

According to another aspect of embodiments of this disclosure, an electronic device is further provided, including a memory and a processor. The memory has a computer program stored therein, and the processor is configured to perform the foregoing virtual object interaction method by using the computer program.

### BRIEF DESCRIPTION OF THE DRAWINGS

The accompanying drawings described herein are configured for providing a better understanding of this disclosure, and form a part of this disclosure. Examples of this disclosure and descriptions thereof are configured for explaining this disclosure, and do not constitute any limitation to this disclosure. In the accompanying drawings:

FIG. 1 is a schematic diagram of an application environment of a virtual object interaction method according to an embodiment of this disclosure.

FIG. 2 is a schematic flowchart of a virtual object interaction method according to an embodiment of this disclosure.

FIG. 3 is a schematic diagram of a virtual object interaction method according to an embodiment of this disclosure.

FIG. 4 is a schematic diagram of a virtual object interaction method according to an embodiment of this disclosure.

FIG. 5 is a schematic diagram of a virtual object interaction method according to an embodiment of this disclosure.

FIG. 6 is a schematic diagram of a virtual object interaction method according to an embodiment of this disclosure.

FIG. 7 is a schematic diagram of a virtual object interaction method according to an embodiment of this disclosure.

FIG. 8 is a schematic diagram of a virtual object interaction method according to an embodiment of this disclosure.

FIG. 9 is a schematic diagram of a virtual object interaction method according to an embodiment of this disclosure.

FIG. 10 is a schematic diagram of a virtual object interaction method according to an embodiment of this disclosure.

FIG. 11 is a schematic diagram of a virtual object interaction method according to an embodiment of this disclosure.

FIG. 12 is a schematic diagram of a virtual object interaction method according to an embodiment of this disclosure.

FIG. 13 is a schematic diagram of a virtual object interaction method according to an embodiment of this disclosure.

FIG. 14 is a schematic diagram of a virtual object interaction method according to an embodiment of this disclosure.

FIG. 15 is a schematic diagram of a structure of a virtual object interaction apparatus according to an embodiment of this disclosure.

FIG. 16 is a schematic diagram of a structure of a virtual object interaction product according to an embodiment of this disclosure.

FIG. 17 is a schematic diagram of a structure of an electronic device according to an embodiment of this disclosure.

### DETAILED DESCRIPTION

To help a person skilled in the art better understand the solutions of this disclosure, the following describes the technical solutions in example embodiments of this disclosure with reference to the accompanying drawings. The described embodiments are merely some of embodiments of this disclosure rather than all of embodiments of this disclosure. Other embodiments obtained by a person of ordinary skill in the art based on embodiments of this disclosure shall fall within the protection scope of this disclosure.

In the specification, claims, and accompanying drawings of this disclosure, the terms “first”, “second”, and the like are intended to distinguish similar objects but do not necessarily indicate a specific order or sequence. Such used data is changeable under appropriate conditions, so that embodiments of this disclosure described here can be implemented in an order other than those illustrated or described here. Moreover, the terms “include”, “have” and any other variants are intended to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The descriptions of the terms are provided as examples only and are not intended to limit the scope of the disclosure.

Virtual social: A user socially chats with others in the form of a virtual object by using a customizing two-dimensional (2D) or three-dimensional (3D) humanoid model.

This disclosure is described below with reference to embodiments.

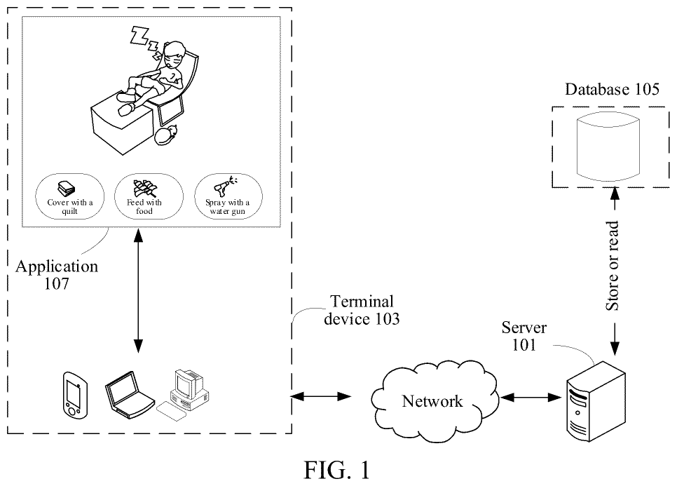

According to one aspect of this disclosure, a virtual object interaction method is provided. In this embodiment, the foregoing virtual object interaction method may be applied to a hardware environment shown in FIG. 1 including a server 101 and a terminal device 103.

As shown in FIG. 1, the server 101 is connected to the terminal device 103 over a network, and may be configured to provide a service for the terminal device 103 or an application installed on the terminal device 103. The application may be a video application, an instant messaging application, a browser application, an educational application, a game application, or the like.

A database 105 may be disposed on the server 101 or independently of the server 101, and be configured to provide a data storage service for the server 101, for example, a game data storage server.

The foregoing network may include, but is not limited to, a wired network and a wireless network. The wired network includes: a local area network, a metropolitan area network, and a wide area network. The wireless network includes: Bluetooth, Wi-Fi, and another network for wireless communication.

The terminal device 103 may be a terminal configured with an application, and may include, but is not limited to, at least one of the following: a mobile phone (such as an Android phone and an iOS phone), a notebook computer, a tablet computer, a palmtop computer, a mobile Internet device (MID), a PAD, a desktop computer, a smart television, an intelligent voice interaction device, a smart home appliance, an on-board terminal, an aircraft, a virtual reality (VR for short) terminal, an augmented reality (AR for short) terminal, a mixed reality (MR for short) terminal, or another computer device. The foregoing server may be a single server, a server cluster including a plurality of servers, or a cloud server.

Refer to FIG. 1. The foregoing virtual object interaction method may be implemented on the terminal device 103 by using the following operations:
S1: Display a virtual scene in a target application on the terminal device 103, and display a first virtual object in a target virtual state in the virtual scene.
S2: Display a target interaction interface on the terminal device 103 in response to a first interaction operation performed on the first virtual object, the target interaction interface being provided with at least one interaction option corresponding to the target virtual state, and each interaction option corresponding to an interaction mode for interacting with the first virtual object.
S3: Display first target interaction information on the terminal device 103 in response to a second interaction operation performed on a first interaction option, the first interaction option being an interaction option selected in the target interaction interface based on the second interaction operation, and the first target interaction information representing an interaction effect associated with the first interaction option and displayed for the first virtual object.

In this embodiment, the foregoing virtual object interaction method may alternatively be implemented by a server, for example, the server 101 shown in FIG. 1; or by a terminal device and a server jointly, for example, the terminal device 103 and the server 101 shown in FIG. 1.

The foregoing description is merely an example, which is not specifically limited in embodiments.

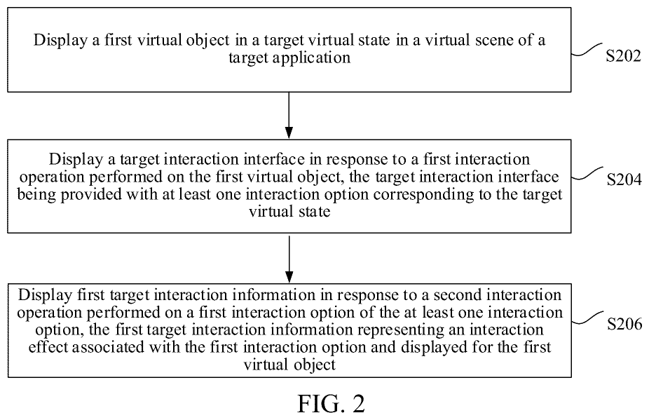

FIG. 2 is a schematic flowchart of a virtual object interaction method according to an embodiment of this disclosure. The method is performed by an electronic device, for example, the terminal device 103 and/or the server 101 as shown in FIG. 1. As shown in FIG. 2, the foregoing virtual object interaction method includes:

S202: Display a first virtual object in a target virtual state in a virtual scene of a target application.

In this embodiment, the target application is an application having a virtual object associated with a login account and allowing interaction with the virtual object, including but not limited to a social application, a game application, an e-commerce application, a travel application, and the like.

The foregoing virtual object interaction method may be, but is not limited to, applied to various applications. In an example in which the target application is a game application, the game application may be a multilayer online battle arena (MOBA for short) game or a single-player game (SPG for short). This is not specifically limited herein. The game application may include, but is not limited to, a shooting application, a role-playing application, a real-time strategy application, and the like. The shooting application may include, but is not limited to, a first-person shooting application, a third-person shooting application, and a shooting application capable of switching between a first person and a third person. The target application may also include, but is not limited to, at least one of the following: a two-dimensional (2D for short) game application, a three-dimensional (3D for short) game application, a virtual reality (VR for short) game application, an augmented reality (AR for short) game application, or a mixed reality (MR for short) game application. The foregoing description is merely an example, which is not limited in embodiments.

In this embodiment, the target virtual state may include, but is not limited to, a virtual state preset by an account associated with the first virtual object, or a virtual state preset by a system, or a virtual state preset based on information such as time information, game information, and social information related to the first virtual object.

In an example, the target virtual state may include, but is not limited to, a virtual state in which the first virtual object is sleeping, a virtual state in which the first virtual object is dancing, a virtual state in which the first virtual object is in a specific emotion, a virtual state corresponding to a specific attribute parameter of the first virtual object when being a preset value or being within a preset range, for example, a hungry state in which a virtual hunger value is less than a preset hunger threshold or a tired state in which a virtual energy value is less than a preset energy threshold.

In this embodiment, the first virtual object may be displayed in the virtual scene of the target application, and may be displayed in a combination of one or more forms such as a virtual identity identifier, a virtual image, and a virtual avatar.

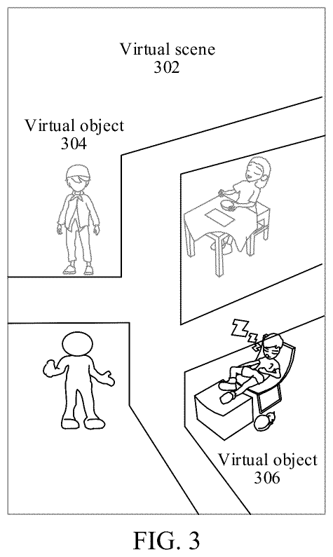

For example, FIG. 3 is a schematic diagram of a virtual object interaction method according to an embodiment of this disclosure. As shown in FIG. 3, a virtual scene 302 of the target application is included. A group of virtual objects, including a virtual object 304, a virtual object 306, and the like, are displayed in the virtual scene 302. Each virtual object corresponds to an account allowed to log in to the target application, and different virtual objects may be in the same or different virtual states. The first virtual object in the target virtual state may be the virtual object 306 shown in FIG. 3.

When the first virtual object in the target virtual state is displayed in the virtual scene of the target application, a group of virtual objects may be displayed in the virtual scene of the target application. The group of virtual objects include the first virtual object and another virtual object.

S204: Display a target interaction interface in response to a first interaction operation performed on the first virtual object, the target interaction interface being provided with at least one interaction option corresponding to the target virtual state.

Each interaction option corresponds to an interaction mode for interacting with the first virtual object.

In this embodiment, the first interaction operation may include, but is not limited to, interaction operations performed on the first virtual object such as clicking/tapping, touching and holding/long pressing, releasing, double-clicking/tapping, a gesture, and a voice.

The target interaction interface may include, but is not limited to, being provided with at least one interaction option allowing interaction with the first virtual object. The interaction option may be set to be an interaction option that matches the target virtual state. For example, when the target virtual state indicates that the first virtual object is in a sleep state, an interaction option corresponding to an interaction mode such as waking up, spraying, covering with a quilt, or feeding food may be performed on the first virtual object.

In this embodiment, the displaying a target interaction interface in response to a first interaction operation performed on the first virtual object may include, but is not limited to, acquiring the target virtual state of the first virtual object in response to the first interaction operation, and displaying the target interaction interface based on the target virtual state.

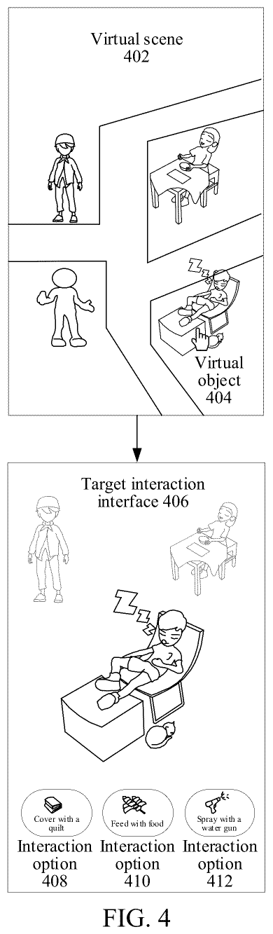

For example, FIG. 4 is a schematic diagram of another exemplary virtual object interaction method according to an embodiment of this disclosure. As shown in FIG. 4, a virtual scene 402 of the target application is included, and a group of virtual objects, including a virtual object 404 and the like, are displayed in the virtual scene 402. A target virtual state of the virtual object 404 is acquired as a sleep state in response to a click/tap operation (corresponding to the first interaction operation) performed on the virtual object 404, and a target interaction interface 406 corresponding to the sleep state is displayed. The target interaction interface 406 includes the at least one interaction option including an interaction option 408, an interaction option 410, and an interaction option 412, and each interaction option is an interaction option allowed to be performed when the first virtual object is in the sleep state.

S206: Display first target interaction information in response to a second interaction operation performed on a first interaction option of the at least one interaction option, the first target interaction information representing an interaction effect associated with the first interaction option and displayed for the first virtual object.

In this embodiment, the second interaction operation may include, but is not limited to, interaction operations performed on the first interaction option such as clicking/tapping, touching and holding/long pressing, releasing, double-clicking/tapping, a gesture, and a voice.

The first target interaction information may include, but is not limited to, interaction content associated with the first interaction option, for example, may include, but is not limited to, text content, animation content, and sound content.

In one embodiment, the first target interaction information may include, but is not limited to, a specific interaction effect associated with the first interaction option and set for the first virtual object. In other words, when the first interaction option corresponding to the target virtual state is triggered, for different virtual objects, interaction effects indicated by the first target interaction information are different.

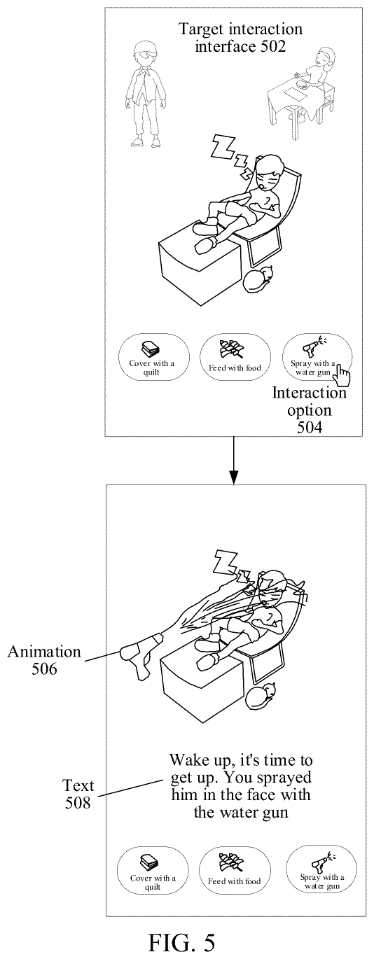

For example, FIG. 5 is a schematic diagram of a virtual object interaction method according to an embodiment of this disclosure. As shown in FIG. 5, a target interaction interface 502 displayed in the target application is included, and the target interaction interface 502 includes an interaction option 504 and other interaction options. The second interaction operation is performed on the interaction option 504, so that an interaction mode associated with the interaction option 504 is started to be performed on the first virtual object. The interaction mode is displayed in the form of the first target interaction information, for example, an animation 506, including displaying an animation of spraying at the first virtual object, and text 508, including displaying text representing that the first virtual object is being sprayed. The animation 506 and the text 508 are both elements of the first target interaction information, to indicate that interaction with the first virtual object is completed.

In this embodiment, the first virtual object in the target virtual state is displayed in the virtual scene of the target application. The target interaction interface is displayed in response to the first interaction operation performed on the first virtual object, where the target interaction interface is provided with the at least one interaction option corresponding to the target virtual state. The first target interaction information is displayed in response to the second interaction operation performed on the first interaction option of the at least one interaction option, where the first interaction option is an interaction option selected by the second interaction operation in the target interaction interface, and the first target interaction information represents the interaction effect associated with the first interaction option and displayed for the first virtual object. The target interaction interface corresponding to the target virtual state is displayed, so that a user can select the interaction mode corresponding to the target virtual state. The first target interaction information of interaction with the first virtual object associated with the first interaction option is displayed, so that the user can participate in interaction in a personalized manner, thereby achieving the technical effects of enriching an interaction effect of a virtual object, improving interaction willingness between users, and optimizing user experience, and further resolving a technical problem in related art that the users have low willingness to interact with each other because of a monotonous interaction effect of a virtual object.

In an example, the displaying first target interaction information in response to a second interaction operation performed on a first interaction option of the at least one interaction option includes:
determining, in response to the second interaction operation, to display first interaction information or to display second interaction information.

The first interaction information represents an interaction effect of a first expression form displayed for the first virtual object, and the first interaction information is set to be displayed based on a first preset probability.

The second interaction information represents an interaction effect of a second expression form displayed for the first virtual object, the second interaction information is set to be displayed based on a second preset probability, and the second expression form is different from the first expression form.

A preset probability refers to a probability threshold set for displaying interaction information. In a specific implementation, when display is performed based on the preset probability, a random number may be generated first, and then the random number is compared with a threshold represented by the preset probability to determine whether to display corresponding interaction information.

In this embodiment, the first interaction information may be set to a regular interaction mode corresponding to the target virtual state, for example, spraying at the first virtual object at a steady flow rate and displaying text with peaceful semantics to indicate that interaction with the first virtual object is performed in the first expression form.

In this embodiment, the second interaction information may be set to an irregular interaction mode corresponding to the target virtual state, for example, spraying at the first virtual object at a strong flow rate and displaying text with intense semantics to indicate that interaction with the first virtual object is performed in the second expression form.

In this embodiment, the first expression form and the second expression form may include, but are not limited to, any one or a combination of more of interaction amplitude, interaction duration, a display color, and the like. A difference between the first expression form and the second expression form is any one or a combination of more of the following: different interaction amplitude (e.g., interaction effectiveness), different interaction duration, different display colors, and the like of the first interaction information and the second interaction information. The different interaction amplitude means that interaction amplitude of the second interaction information is greater or less than interaction amplitude of the first interaction information, the different interaction duration means that interaction duration of the second interaction information is longer or shorter than interaction duration of the first interaction information, and the different display colors mean that a display color of the second interaction information is brighter or colder than a display color of the first interaction information.

Content corresponding to the foregoing different expression forms may be preset by an account controlling the first virtual object or an account interacting with the first virtual object. The first preset probability and the second preset probability may be preset by a system, or the account controlling the first virtual object, or the account interacting with the first virtual object. The first preset probability and the second preset probability may be the same or different.

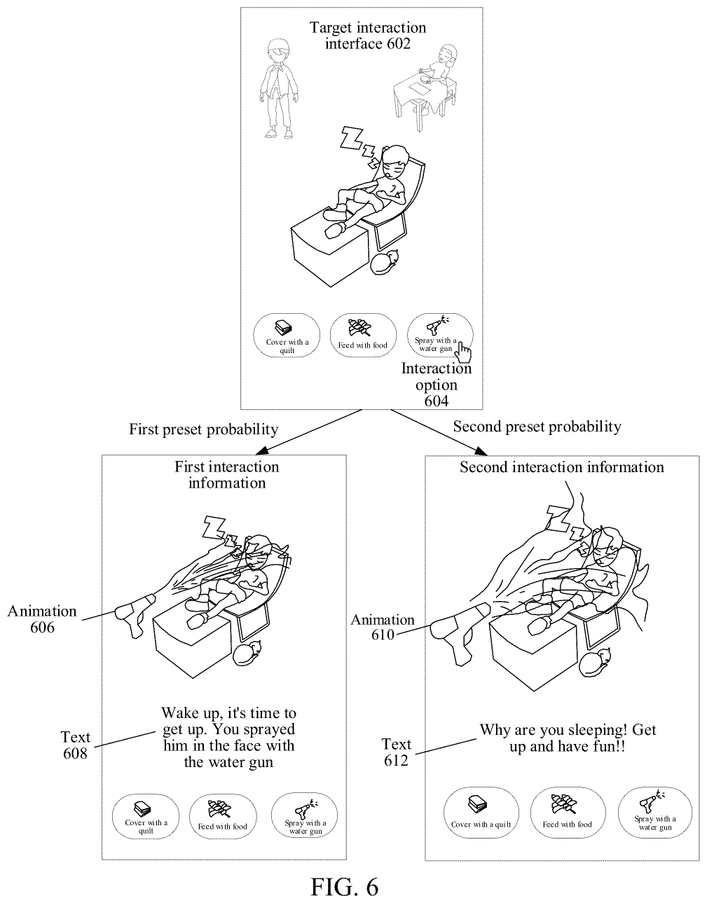

For example, FIG. 6 is a schematic diagram of a virtual object interaction method according to an embodiment of this disclosure. As shown in FIG. 6, a target interaction interface 602 displayed in the target application is included, and the target interaction interface 602 includes an interaction option 604 and other interaction options. The second interaction operation is performed on the interaction option 604, so that an interaction mode associated with the interaction option 604 is started to be performed on the first virtual object. The interaction mode is displayed in the form of the first interaction information or the second interaction information based on the first preset probability or the second preset probability. The first interaction information includes an animation 606 and text 608, and the second interaction information includes an animation 610 and text 612. Both the animation 606 and the animation 610 represent animations of spraying at the first virtual object, but interaction amplitude of the animation 610 is greater than that of the animation 606, in other words, a water spray rate of the animation 610 is higher than that of the animation 606. Both the text 608 and the text 612 represent text that the first virtual object is sprayed, but interaction amplitude of the text 612 is greater than that of the text 608, in other words, semantic intensity of the text 612 is greater than that of the text 608.

In this embodiment, when interaction is initiated with the first virtual object, different interaction information may be displayed based on probabilities to increase randomness of the interaction effect, so as to avoid that the interaction effect is monotonous.

In an example, when the second interaction information is displayed in response to the second interaction operation performed on the first interaction option, interaction amplitude corresponding to the second expression form is greater than interaction amplitude corresponding to the first expression form, and the first preset probability is greater than the second preset probability. Alternatively, the interaction amplitude corresponding to the second expression form is less than the interaction amplitude corresponding to the first expression form, and the first preset probability is greater than the second preset probability.

In this embodiment, the interaction amplitude may include, but is not limited to, a range of motion indicating an interaction activity, a rate of an interaction activity, a quantity of interaction activities, and the like.

In this embodiment, the first preset probability being greater than the second preset probability means that when a user performs the second interaction operation on the first interaction option, the second interaction information is displayed with a less probability, and the first interaction information is displayed with a greater probability. For example, the first expression form may be understood as a regular attack operation, and the second expression form may be understood as a critical attack operation. In this case, the first interaction information corresponding to the first expression form indicates an interaction activity performed in a regular case, and the second interaction information corresponding to the second expression form indicates an interaction activity performed in an irregular case.

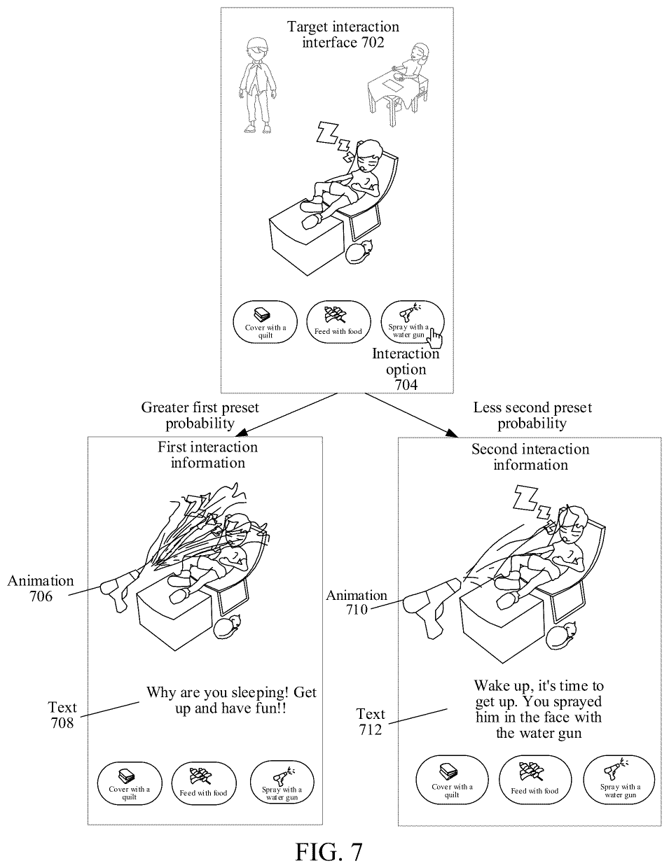

For example, FIG. 7 is a schematic diagram of a virtual object interaction method according to an embodiment of this disclosure. As shown in FIG. 7, a target interaction interface 702 displayed in the target application is included, and the target interaction interface 702 includes an interaction option 704 and other interaction options. The second interaction operation is performed on the interaction option 704, so that an interaction mode associated with the interaction option 704 is started to be performed on the first virtual object. The interaction mode is displayed in the form of the first interaction information or the second interaction information based on the first preset probability or the second preset probability. In an example in which the first preset probability is 0.8, and the second preset probability is 0.2, if 100 users perform the second interaction operation on the first virtual object, about 80 users are displayed with the second interaction information, and about 20 users are displayed with the first interaction information. The first interaction information includes an animation 706 and text 708, and the second interaction information includes an animation 710 and text 712. Both the animation 706 and the animation 710 represent animations of spraying at the first virtual object, but interaction amplitude of the animation 706 is greater than that of the animation 710, in other words, a water spray rate of the animation 706 is higher than that of the animation 710. Both the text 712 and the text 708 represent text that the first virtual object is sprayed, but interaction amplitude of the text 708 is greater than that of the text 712, in other words, semantic intensity of the text 708 is greater than that of the text 712.

In this embodiment, when interaction is initiated with the first virtual object, interaction information with different interaction amplitude may be displayed based on different probabilities to increase randomness of the interaction effect, so as to avoid a technical problem that the interaction effect is monotonous, thereby optimizing user experience and avoiding monotony.

In one embodiment, the first target interaction information is set to be associated with both the first virtual object and the first interaction option, and degrees of association may be different.

In an example, the displaying first target interaction information in response to a second interaction operation performed on a first interaction option of the at least one interaction option includes at least one of the following:
displaying target text information in response to the second interaction operation, the target text information being configured for representing a text interaction effect associated with the first interaction option and displayed for the first virtual object;
displaying target animation information in response to the second interaction operation, the target animation information being configured for representing an animation interaction effect associated with the first interaction option and displayed for the first virtual object; or
displaying target sound information in response to the second interaction operation, the target sound information being configured for representing a sound interaction effect associated with the first interaction option and displayed for the first virtual object.

In this embodiment, the target text information is text information indicating that interaction with the first virtual object associated with the first interaction option is performed. For example, if the target virtual state indicates that the first virtual object is sleeping, the text information may indicate text for waking up the first virtual object, text for teasing the first virtual object, and the like. The target text information may also be associated with a meaning of the first interaction option itself, and also with the first virtual object, for example, with a name, a nickname, or a name of a type of the first virtual object, for example, “XX, it's time to get up!”. “XX” is the name of the first virtual object or the name of the type to which the first virtual object belongs. In this case, the target text information may have a low degree of association with the meaning of the first interaction option itself.

In this embodiment, the target animation information is animation information indicating that interaction with the first virtual object associated with the first interaction option is performed. For example, if the target virtual state indicates that the first virtual object is sleeping, the animation information may indicate animation for waking up the first virtual object, animation for teasing the first virtual object, and the like. Certainly, the target animation information may also be associated with a meaning of the first interaction option itself, and also with the first virtual object. For example, a virtual model of the first virtual object in the target animation information also changes. In an example in which the first virtual object is sprayed, when spray with a water gun is shown to spray at the first virtual object, the first virtual object may jump up from a virtual bed. In this case, the target animation information may have a low degree of association with the meaning of the first interaction option itself.

In this embodiment, the target sound information is sound information indicating that interaction with the first virtual object associated with the first interaction option is performed. For example, if the target virtual state indicates that the first virtual object is sleeping, the sound information may indicate a sound for waking up the first virtual object, a sound for teasing the first virtual object, and the like. Certainly, the target sound information may also be associated with a meaning of the first interaction option itself, and also with the first virtual object. For example, a timbre of the first virtual object in the target sound information also changes. In an example in which the first virtual object is sprayed, when spray with a water gun is shown to spray at the first virtual object, a sound of spraying is played back. When spray duration reaches preset duration, the first virtual object may jump up from a virtual bed and voice information generated by the first virtual object is played back. A timbre of the voice information may be different from that in a regular state. In this case, the target sound information may have a low degree of association with the meaning of the first interaction option itself.

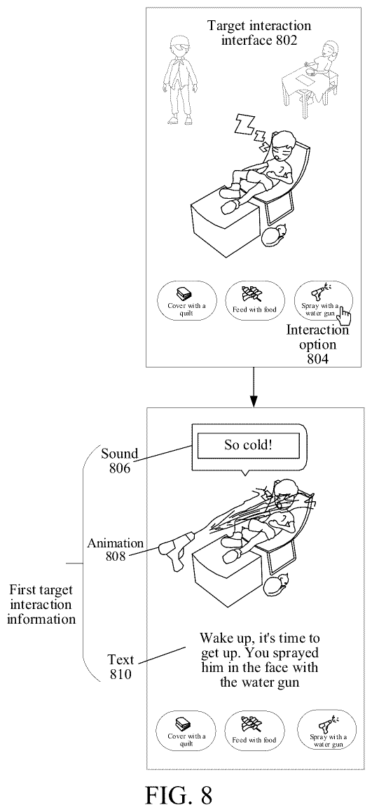

For example, FIG. 8 is a schematic diagram of a virtual object interaction method according to an embodiment of this disclosure. As shown in FIG. 8, a target interaction interface 802 displayed in the target application is included, and the target interaction interface 802 includes an interaction option 804 and other interaction options. The second interaction operation is performed on the interaction option 804, so that an interaction mode associated with the interaction option 804 is started to be performed on the first virtual object. The interaction mode is displayed in the form of the target text information (such as text 810), target animation information (such as animation 808), and target sound information (a sound 806). Specifically, the sound 806 includes playing back voice information generated based on a preset timbre of the first virtual object, the animation 808 includes an animation of spraying at the first virtual object, and the text 810 includes displaying text indicating that the first virtual object is being sprayed. The sound 806, the animation 808, and the text 810 are all elements of the first target interaction information, to indicate that interaction with the first virtual object is completed.

In an exemplary solution, after the displaying first target interaction information in response to a second interaction operation performed on a first interaction option of the at least one interaction option, the method further includes: displaying the target interaction interface again; and displaying second target interaction information in response to a third interaction operation performed on the first interaction option, an expression form of the second target interaction information being different from an expression form of the first target interaction information.

In this embodiment, the third interaction operation may include, but is not limited to, interaction operations performed on the first interaction option such as clicking/tapping, touching and holding/long pressing, releasing, double-clicking/tapping, a gesture, and a voice.

In this embodiment, the target interaction interface displayed again is an interaction interface displayed in the target application after the first target interaction information is displayed. In other words, when the first target interaction information is displayed or display duration satisfies a preset condition, the target interaction interface is redisplayed to facilitate interaction with the first virtual object again. The third interaction operation is configured for indicating that the first interaction option is selected again. In this case, the second target interaction information is displayed.

In this embodiment, the second target interaction information may include, but is not limited to, interaction content associated with the first interaction option and different from the first target interaction information, for example, may include, but is not limited to, any one or a combination of more of different text content, different animation content, and different sound content.

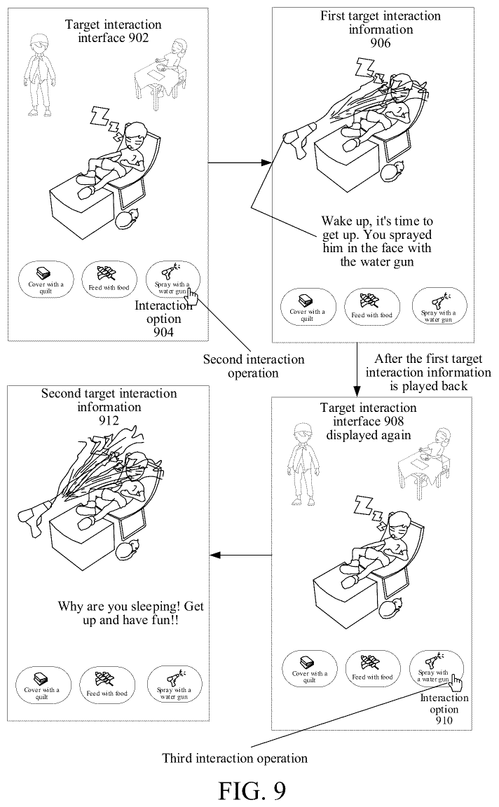

For example, FIG. 9 is a schematic diagram of a virtual object interaction method according to an embodiment of this disclosure. As shown in FIG. 9, a target interaction interface 902 displayed in the target application is included, and the target interaction interface 902 includes an interaction option 904 and other interaction options. The second interaction operation is performed on the interaction option 904, so that an interaction mode associated with the interaction option 904 is started to be performed on the first virtual object. The interaction mode is displayed in the form of first target interaction information 906. When display of the first target interaction information 906 satisfies a preset condition, target interaction interface 908 is displayed again. The target interaction interface 908 includes an interaction option 910 and other interaction options. The third interaction operation is performed on the interaction option 910, so that an interaction mode associated with the interaction option 910 is started to be performed on the first virtual object.

When the interaction option 910 and the interaction option 904 are the same interaction option, an interaction effect of the second target interaction information is allowed to be different from an interaction effect of the first target interaction information. For example, interaction amplitude of the second target interaction information is greater than interaction amplitude of the first target interaction information, or the interaction amplitude of the second target interaction information is less than the interaction amplitude of the first target interaction information.

In another embodiment, after the displaying first target interaction information in response to a second interaction operation performed on a first interaction option of the at least one interaction option, the method further includes: displaying the target interaction interface again; and displaying fourth target interaction information in response to a fifth interaction operation performed on a third interaction option, an expression form of the fourth target interaction information being obtained by updating an expression form of the first target interaction information.

In other words, when the target interaction interface is displayed again, the interaction option 910 and the interaction option 904 at the same position of the interface are different interaction options. In this case, the interaction effect of the second target interaction information may be superimposed with another interaction effect based on the interaction effect of the first target interaction information, or may be combined with another interaction effect. The superimposed display may include, but is not limited to, displaying the interaction effect of the first target interaction information and another interaction effect at the same time, and the combined display may include, but is not limited to, changing the first target interaction information corresponding to the interaction option 904 to obtain updated combined target interaction information as the fourth target interaction information.

In this embodiment, when a plurality of times of interaction are initiated with the first virtual object, different interaction information may be displayed, and different interaction effects may be produced, so that interaction willingness between users is improved, thereby optimizing user experience.

In an example, the displaying second target interaction information in response to a third interaction operation performed on the first interaction option includes:
determining, in response to the third interaction operation, to display third interaction information or to display fourth interaction information.

The third interaction information represents an interaction effect of a third expression form displayed for the first virtual object, and interaction amplitude corresponding to the third expression form is greater than interaction amplitude corresponding to the expression form of the first target interaction information.

The fourth interaction information represents an interaction effect of a fourth expression form displayed for the first virtual object, and interaction amplitude corresponding to the fourth expression form is less than the interaction amplitude corresponding to the expression form of the first target interaction information.

In this embodiment, the interaction amplitude may include, but is not limited to, a range of motion indicating an interaction activity, a rate of an interaction activity, a quantity of interaction activities, and the like.

In this embodiment, the first expression form refers to a regular attack operation, and the third expression form refers to a critical attack operation. In this case, the first interaction information corresponding to the first expression form indicates an interaction activity performed in a regular case, and the third interaction information corresponding to the third expression form indicates an interaction activity performed in an irregular case.

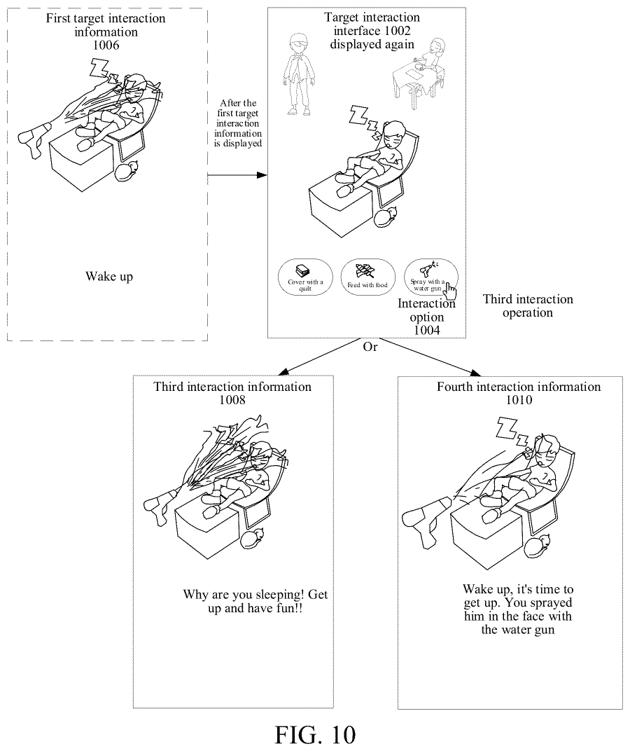

For example, FIG. 10 is a schematic diagram of another exemplary virtual object interaction method according to an embodiment of this disclosure. As shown in FIG. 10, a target interaction interface displayed in the target application is included. The second interaction operation is performed on an interaction option, so that an interaction mode associated with the interaction option is started to be performed on the first virtual object. The interaction mode is displayed in the form of first target interaction information 1006. When display of the first target interaction information 1006 satisfies a preset condition, target interaction interface 1002 is displayed again. The target interaction interface 1002 displayed again includes an interaction option 1004 and other interaction options. The third interaction operation is performed on the interaction option 1004, so that an interaction mode associated with the interaction option 1004 is started to be performed on the first virtual object, and third interaction information 1008 or fourth interaction information 1010 is displayed. It can be learned from FIG. 10 that, a spray effect of the third interaction information 1008 is significantly more powerful than that of the first target interaction information 1006, and a spray effect of the fourth interaction information 1010 is significantly less powerful than that of the first target interaction information 1006.

In this embodiment, when a plurality of times of interaction are initiated with the first virtual object, interaction information with different interaction amplitude may be displayed for each interaction process to increase progressiveness of the interaction effect, so as to avoid that the interaction effect is monotonous, thereby optimizing user experience and avoiding monotony.

In an example, after the displaying second target interaction information in response to a third interaction operation performed on the first interaction option, the method further includes:
displaying the target interaction interface again; and
displaying third target interaction information in response to a fourth interaction operation performed on the first interaction option, an expression form of the third target interaction information being different from the expression form of the first target interaction information and the expression form of the second target interaction information.

In this embodiment, the fourth interaction operation may include, but is not limited to, displaying the target interaction interface again after the second target interaction information is displayed or the display satisfies a preset condition, and acquiring the fourth interaction operation performed on the first interaction option (or an interaction option other than the first interaction option) again to display the third target interaction information.

In this embodiment, the fourth interaction operation may include, but is not limited to, interaction operations performed on the first interaction option such as clicking/tapping, touching and holding/long pressing, releasing, double-clicking/tapping, a gesture, and a voice.

In this embodiment, the target interaction interface is an interaction interface displayed in the target application after the second target interaction information is displayed. In other words, when the second target interaction information is displayed or display duration satisfies a preset condition, the target interaction interface is redisplayed to facilitate interaction with the first virtual object again. The fourth interaction operation is configured for indicating that the first interaction option is selected again. In this case, the third target interaction information is displayed.

In this embodiment, the third target interaction information may include, but is not limited to, interaction content associated with the first interaction option and different from the first target interaction information and the second target interaction information, for example, may include, but is not limited to, any one or a combination of more of different text content, different animation content, and different sound content.

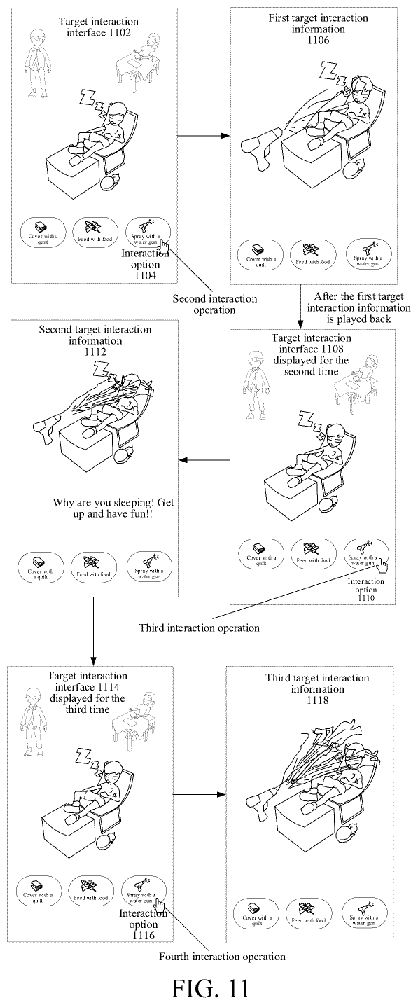

For example, FIG. 11 is a schematic diagram of a virtual object interaction method according to an embodiment of this disclosure. As shown in FIG. 11, a target interaction interface 1102 displayed in the target application is included, and the target interaction interface 1102 includes an interaction option 1104 and other interaction options. The second interaction operation is performed on the interaction option 1104, so that an interaction mode associated with the interaction option 1104 is started to be performed on the first virtual object. The interaction mode is displayed in the form of first target interaction information 1106. When display of the first target interaction information 1106 satisfies a preset condition, target interaction interface 1108 is displayed again (to be specific, displayed for the second time). The target interaction interface 1108 displayed again includes an interaction option 1110 and other interaction options. The third interaction operation is performed on the interaction option 1110, so that an interaction mode associated with the interaction option 1110 is started to be performed on the first virtual object. The interaction mode is displayed in the form of second target interaction information 1112. When display of the second target interaction information 1112 satisfies a preset condition, target interaction interface 1114 is displayed for the third time. The target interaction interface 1114 displayed for the third time includes an interaction option 1116 and other interaction options. The fourth interaction operation is performed on the interaction option 1116, so that an interaction mode associated with the interaction option 1116 is started to be performed on the first virtual object. The interaction mode is displayed in the form of third target interaction information 1118.

In this embodiment, when a plurality of times of interaction are initiated with the first virtual object, different interaction information may be displayed, and different interaction effects may be produced, so that interaction willingness between users is improved, thereby optimizing user experience.

In an example, content of the second target interaction information is preset by an account controlling the first virtual object. Alternatively, content of the second target interaction information is preset by an account interacting with the first virtual object.

In this embodiment, the content of the second target interaction information being preset by the account controlling the first virtual object means that after logging in to the target application, each account may set content of interaction information displayed when another account initiates interaction with the account. The content of the second target interaction information being preset by the account interacting with the first virtual object means that after logging in to the target application, each account may set content of interaction information displayed when the account initiates interaction with another account.

Corresponding content such as an animation, text, and a sound may be set for each interaction option, and the content may include, but is not limited to, any one or a combination of more of the above. For each interaction option, interaction information displayed when the interaction option is first initiated and interaction information displayed when the interaction option is initiated again as well as including, but is not limited to, interaction information displayed each time the interaction option is initiated may be set. Content of the interaction information displayed each time the interaction option is initiated may be set individually or uniformly.

In an example, content of the first target interaction information is preset, based on the target virtual state, by an account controlling the first virtual object. Alternatively, content of the first target interaction information is preset, based on the target virtual state, by an account interacting with the first virtual object.

In this embodiment, the content of the first target interaction information being preset, based on the target virtual state, by the account controlling the first virtual object means that the account controlling the first virtual object sets content of corresponding interaction information for different virtual states and different interaction options, respectively. In an example in which the first virtual object is in a sleep state, two pieces of text information may be set for the sleep state, including: “Wake up” and “Please wake up!!!”. The two different text information are displayed based on a specific probability. When the first virtual object is in the sleep state and the interaction options include “spray”, “feed with food”, and “cover with a quilt”, the “feed with food” interaction option in the sleep state may be set with “I don't want to cat, take it away!” as the text information in the first target interaction information, and the “cover with a quilt” interaction option in the sleep state may be set with “I'm warm now, thank you!” as the text information in the first target interaction information.

In other words, the first target interaction information may be set separately based on different virtual states of the first virtual object, and may also be set separately based on different virtual states of the first virtual object and corresponding interaction options.

In this embodiment, the content of the first target interaction information may be set by the account controlling the first virtual object, so that different interaction effects may be produced by an account initiating interaction in a process of interacting with different first virtual objects, so that interaction willingness between users is improved, thereby optimizing user experience.

In an example, the displaying a first virtual object in a target virtual state in a virtual scene of a target application includes: displaying a group of virtual objects in the virtual scene, the group of virtual objects including a plurality of virtual objects that are allowed to initiate interaction, and each virtual object of the group of virtual objects being in a preset virtual state. The displaying a target interaction interface in response to a first interaction operation performed on the first virtual object includes: acquiring the target virtual state of the first virtual object in response to the first interaction operation, and displaying the target interaction interface based on the target virtual state.

In this embodiment, the virtual scene of the target application may include, but is not limited to, a virtual scene in which at least two virtual objects are both displayed. In this case, an account logged in to the target application may select the first virtual object from the group of virtual objects through the first interaction operation, so that a user can actively select a virtual object to be interacted with.

In an example, when a second virtual object interacts with a third virtual object, the method further includes: displaying a target prompt message in the target application, the target prompt message being configured for prompting that the second virtual object performs interaction associated with a second interaction option with the third virtual object, the second virtual object being a virtual object controlled by an account logging in to the target application, and the second interaction option being an interaction option selected by an account controlling the third virtual object; and displaying the third virtual object in the virtual scene of the target application in response to a trigger interaction operation performed on the target prompt message.

In an exemplary embodiment, the second virtual object is a virtual object that initiates an interaction request to the first virtual object in the target application, and the third virtual object is a virtual object that initiates an interaction request to the second virtual object.

For example, in an example in which the first virtual object is virtual object A, the second virtual object is virtual object B, and the third virtual object is virtual object C, the method includes:
displaying virtual object A in the target virtual state on the terminal where virtual object B logs in to the target application and in the virtual scene of the target application, displaying the target interaction interface in response to the first interaction operation performed on virtual object A, and displaying, in response to a second interaction operation performed on the first interaction option, interaction information indicating that virtual object B performs interaction associated with the first interaction option with virtual object A; and
displaying virtual object B in the target virtual state on the terminal where virtual object C logs in to the target application and in the virtual scene of the target application, displaying the target interaction interface in response to an interaction operation performed on virtual object B, and displaying, in response to an interaction operation performed on the second interaction option, interaction information indicating that virtual object C performs interaction associated with the second interaction option with virtual object B.

When virtual object C performs the interaction associated with the second interaction option with virtual object B, the target prompt message is displayed in the target application.

In this embodiment, the target prompt message may include, but is not limited to, a pop-up message, a text message, and another social message. The trigger interaction operation is performed on the social message, so that a position of the third virtual object in the virtual scene may be obtained, and then the third virtual object is displayed in the virtual scene. The trigger interaction operation may be implemented in the same or different manner as the first interaction operation.

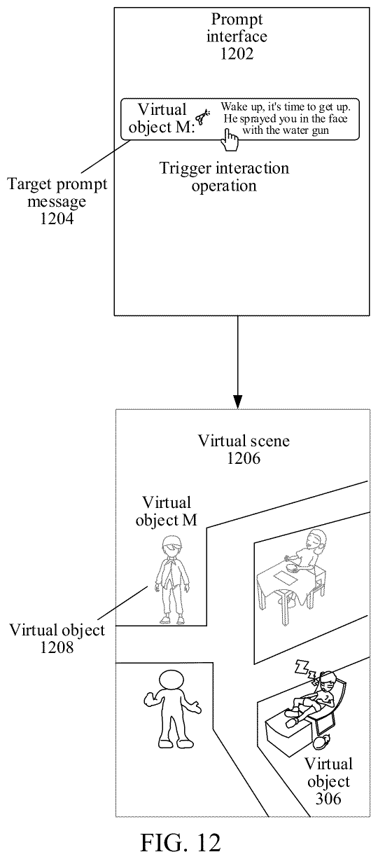

For example, FIG. 12 is a schematic diagram of a virtual object interaction method according to this disclosure. As shown in FIG. 12, a prompt interface 1202 displayed in the target application is included, and the prompt interface 1202 includes a target prompt message 1204, which indicates interaction initiated by the third virtual object to the second virtual object. The trigger interaction operation is performed by using the target prompt message 1204 to obtain a position of the third virtual object in a virtual scene 1206, in other words, a virtual object 1208 in the virtual scene 1206.

This disclosure is further described in detail with reference to the following specific examples.

In virtual social, interaction is a main mode of an activity between characters. Existing interaction is mainly text, a picture, and like, which is not vivid and interesting enough without participation of a virtual image (corresponding to the foregoing virtual object). With the help of an appearance of the virtual image, it is possible to express an emotion to a user associated with the virtual object by interacting with the virtual object.

This disclosure provides a manner for interacting with a virtual character image, to form closed-loop experience with an initiator interacting and a recipient being notified.

An application scenario of this disclosure is as follows. In a virtual scene, a friend of a user has a fixed set state at a current moment. For example, if the friend sets that he/she is sleeping, an image of the friend may be a sleeping image. The user double-clicks/taps on the character to call up a specific interaction interface, on which the user may select an interaction option for this sleep state. For example, if spray with a water gun is selected, an animation and text for the spray with a water gun may be played back. If a critical hit is triggered, an effect of the water spray gun may be more exaggerated, and semantic intensity of the text may be greater, which is different from normal interaction in description and effect. After interaction is performed, the friend being interacted with may receive an interaction notification, informing that who has interacted with the friend and what interaction activity is performed. The friend may click/tap on the notification to find out the person who initiates the interaction in the virtual world and generate more interaction.

An interaction process and details of this solution are as follows.
S1: Double-click/tap on a character to be interacted with in the virtual scene to call up the interaction interface.
S2: Display an interaction option based on a current state of the character. For example, if a virtual object is sleeping, an interaction button may be “cover with a quilt”, “feed with food”, “spray with a water gun”, and the like. Different states may correspond to different interaction options.
S3: The user selects the spray with a water gun to play back an interaction animation. Specifically, a water gun spraying at the character may be displayed, and the character may get wet, in addition, interaction text may be displayed.
S4: If a critical hit effect is triggered, an effect may be more exaggerated and the text may be different.
S5: After the effect is played back, return to the interaction interface, with a previously selected interaction button lighting up again, and then continue interaction.
S6: A user being interacted with may receive an interaction notification. The user may click/tap on the notification to locate a user role that initiates the interaction.

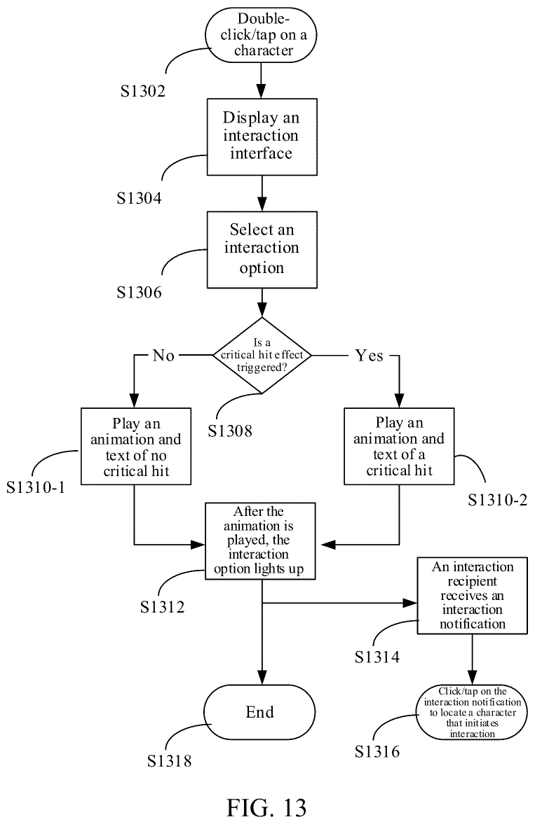

FIG. 13 is a schematic diagram of a virtual object interaction method according to an embodiment of this disclosure. As shown in FIG. 13, an operation process is as follows:

S1302: An interaction initiator double-clicks/taps on a target virtual character.

For example, the interaction initiator is user A, and user A double-clicks/taps on character B on a display interface of a virtual scene.

S1304: Display an interaction interface on a terminal screen of the interaction initiator.

The displayed interaction interface includes an image of a character and an interaction option button corresponding to a state of the character. Based on different states, there may be different option buttons to indicate different interaction modes.

S1306: The interaction initiator selects an interaction option.

S1308: A background determines whether a critical hit effect is triggered.

After user A clicks/taps one of the interaction buttons, the background randomly determines whether the critical hit effect is triggered.

For example, a random number is generated and compared with a preset probability threshold to determine whether the critical hit effect is triggered.

A difference between no critical hit and critical hit lies in an animation effect and text. An animation effect of the critical hit may be more exaggerated than that of no critical hit.

S1310-1: When a result of S1308 is no, play back the animation and text of no critical hit on the terminal screen of the interaction initiator.

S1310-2: When a result of S1308 is yes, play back the animation and text of the critical hit on the terminal screen of the interaction initiator.

The animation is played back on a playback interface, and the character may also be shown with the animation and corresponding text. During animation playback, the interaction button is temporarily unavailable.

S1312: After the animation is played back, return to the interaction interface, with the interaction option lighting up, and perform operation S1318: end.

After the animation is played back (usually for 2-6 seconds), the interaction button changes to be available.

S1314: An interaction recipient receives an interaction notification.

User B, as the interaction recipient, may receive an interaction prompt, indicating user B who has interacted with a character of user B.

S1316: The interaction recipient clicks/taps on the interaction notification to locate a virtual character corresponding to the interaction initiator.

User B may click/tap on the prompt to locate a position of a virtual character corresponding to user A in the interaction interface.

S1318: End the current process.

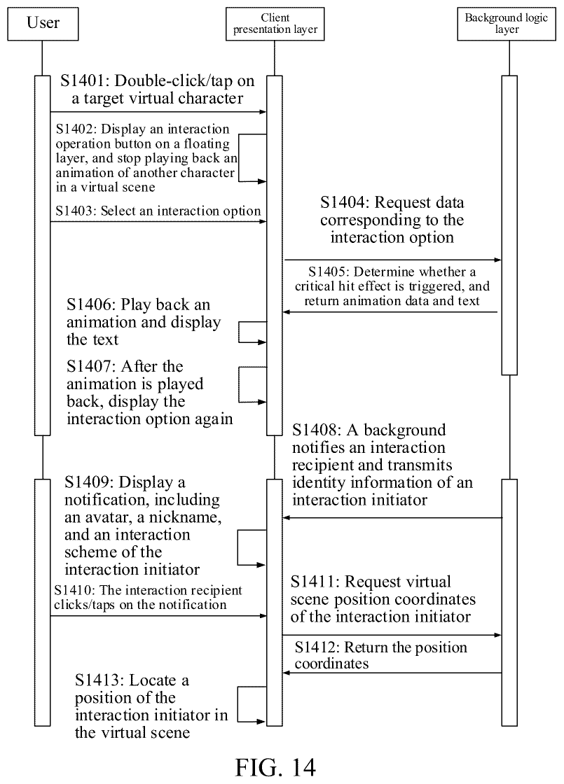

FIG. 14 is a schematic diagram of a virtual object interaction method according to an embodiment of this disclosure. A specific sequence diagram of this disclosure between a user, a client presentation layer, and a background logic layer is shown in FIG. 14, including the following operations:
S1401: A user double-clicks/taps on a target virtual character displayed in a virtual scene interface.

The user in this case is an interaction initiator.
S1402: The client presentation layer displays a floating layer (for example, a floating layer in a black mask style) on the virtual scene interface, displays an interaction operation button on the floating layer, and in this case, stops playing back an animation of another character in a virtual scene.
S1403: The user selects an interaction option.
S1404: The client presentation layer requests data corresponding to the interaction option from the background logic layer.
S1405: The background logic layer determines whether a critical hit effect is triggered, and returns corresponding animation data and text to the client presentation layer.
S1406: The client presentation layer plays back an animation and displays the text.
S1407: After the animation is played back, the client presentation layer displays the interaction option again.
S1408: The background logic layer notifies a client presentation layer of an interaction recipient and transmits identity information of the interaction initiator.
S1409: The client presentation layer of the interaction recipient displays a notification, including an avatar, a nickname, and an interaction scheme of the interaction initiator.
S1410: The interaction recipient clicks/taps on the notification.
S1411: The client presentation layer of the interaction recipient requests virtual scene position coordinates of the interaction initiator from the background logic layer.
S1412: The background logic layer returns the requested position coordinates.
S1413: The client presentation layer of the interaction recipient locates a position of the interaction initiator in the virtual scene.

It may be learned that embodiments of this disclosure provide a lightweight interaction system, which can provide a specific interaction response for a specific state of a user and can be combined with a character to provide a stronger sense of interaction. An interaction recipient can receive interaction activity information timely, so that a social closed loop is formed, to facilitate consolidation of a social relationship.

In the specific implementation of this disclosure, relevant data such as user information is involved. When the foregoing embodiments of this disclosure are applied to a specific product or technology, a permission or consent of a user is required, and collection, use, and processing of the related data need to comply with relevant laws, regulations, and standards of relevant countries and regions.

For each of the foregoing method embodiments, for case of description, the method embodiments are described as a series of action combination. But a person of ordinary skill in the art is to know that this disclosure is not limited to any described sequence of the action, as some operations can use other sequences or can be executed simultaneously according to this disclosure. In addition, a person skilled in the art also knows that embodiments described in the specification are examples, and the related actions and modules are not necessarily required by this disclosure.

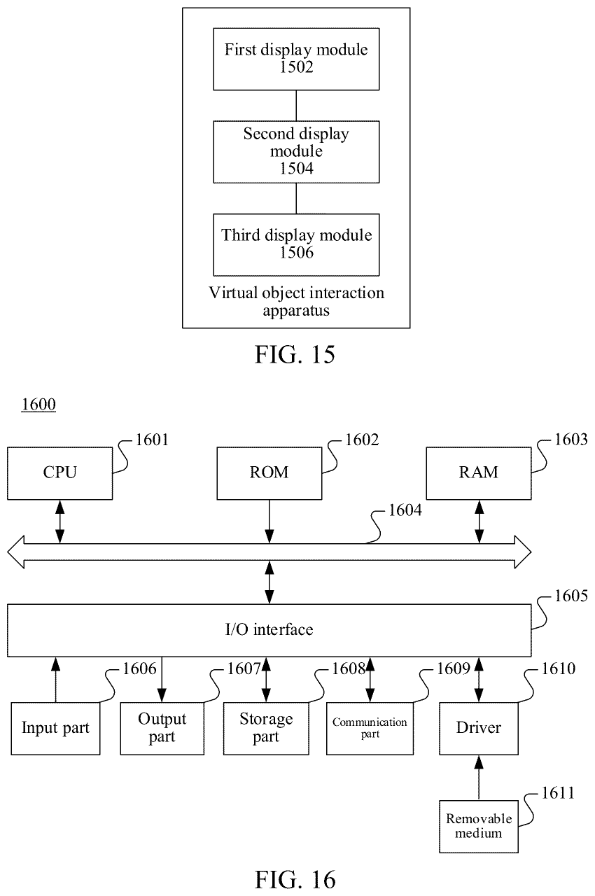

According to an aspect of this disclosure, a virtual object interaction apparatus for implementing the foregoing method is further provided. As shown in FIG. 15, the apparatus includes:
a first display module 1502, configured to display a first virtual object in a target virtual state in a virtual scene of a target application;
a second display module 1504, configured to display a target interaction interface in response to a first interaction operation performed on the first virtual object, the target interaction interface being provided with at least one interaction option corresponding to the target virtual state; and
a third display module 1506, configured to display first target interaction information in response to a second interaction operation performed on a first interaction option of the at least one interaction option, the first target interaction information representing an interaction effect associated with the first interaction option and displayed for the first virtual object.

As an example, the third display module 1506 is configured to determine, in response to the second interaction operation, to display first interaction information or to display second interaction information. The first interaction information represents an interaction effect of a first expression form displayed for the first virtual object, and the first interaction information is set to be displayed based on a first preset probability. The second interaction information represents an interaction effect of a second expression form displayed for the first virtual object, the second interaction information is set to be displayed based on a second preset probability, and the second expression form is different from the first expression form.

As an example, interaction amplitude corresponding to the second expression form is greater than interaction amplitude corresponding to the first expression form, and the first preset probability is greater than the second preset probability.

As an example, interaction amplitude corresponding to the second expression form is less than interaction amplitude corresponding to the first expression form, and the first preset probability is greater than the second preset probability.

As an example, the third display module 1506 is configured to: display target text information in response to the second interaction operation, the target text information being configured for representing a text interaction effect associated with the first interaction option and displayed for the first virtual object;
display target animation information in response to the second interaction operation, the target animation information being configured for representing an animation interaction effect associated with the first interaction option and displayed for the first virtual object; or
display target sound information in response to the second interaction operation, the target sound information being configured for representing a sound interaction effect associated with the first interaction option and displayed for the first virtual object.

As an example, the third display module 1506 is further configured to: display the target interaction interface again; and display second target interaction information in response to a third interaction operation performed on the first interaction option, an expression form of the second target interaction information being different from an expression form of the first target interaction information.

As an example, the third display module 1506 is configured to determine, in response to the third interaction operation, to display third interaction information or to display fourth interaction information. The third interaction information represents an interaction effect of a third expression form displayed for the first virtual object, and interaction amplitude corresponding to the third expression form is greater than interaction amplitude corresponding to the expression form of the first target interaction information. The fourth interaction information represents an interaction effect of a fourth expression form displayed for the first virtual object, and interaction amplitude corresponding to the fourth expression form is less than the interaction amplitude corresponding to the expression form of the first target interaction information.

As an example, the third display module 1506 is further configured to: display the target interaction interface again; and display third target interaction information in response to a fourth interaction operation performed on the first interaction option, an expression form of the third target interaction information being different from the expression form of the first target interaction information and the expression form of the second target interaction information.

As an example, content of the second target interaction information is preset by an account controlling the first virtual object. Alternatively, content of the second target interaction information is preset by an account interacting with the first virtual object.

As an example, content of the first target interaction information is preset, based on the target virtual state, by an account controlling the first virtual object. Alternatively, content of the first target interaction information is preset, based on the target virtual state, by an account interacting with the first virtual object.

As an example, the first display module 1502 is configured to display a group of virtual objects in the virtual scene, the group of virtual objects including a plurality of virtual objects that are allowed to initiate interaction, and each virtual object of the group of virtual objects being in a preset virtual state.

The second display module 1504 is configured to acquire the target virtual state of the first virtual object in response to the first interaction operation, and display the target interaction interface based on the target virtual state.

As an example, the apparatus further includes:
a fourth display module, configured to: display a target prompt message in the target application, the target prompt message being configured for prompting that a second virtual object performs interaction associated with a second interaction option with a third virtual object, the second virtual object being a virtual object controlled by an account logging in to the target application, and the second interaction option being an interaction option selected by an account controlling the third virtual object; and display the third virtual object in the virtual scene of the target application in response to a trigger interaction operation performed on the target prompt message.

As an example, the apparatus further includes:
a fifth display module, configured to: display the target interaction interface again; and display fourth target interaction information in response to a fifth interaction operation performed on a third interaction option, an expression form of the fourth target interaction information being obtained by updating an expression form of the first target interaction information.

According to an aspect in this disclosure, a computer program product is provided. The computer program product includes a computer program/instructions. The computer program/instructions include program code configured for performing the method shown in the flowchart. In such an embodiment, the computer program may be downloaded and installed from a network by using a communication part 1609, and/or installed from a removable medium 1611. When the computer program is executed by a central processing unit 1601, various functions provided in embodiments of this disclosure are performed.

The sequence numbers of the foregoing embodiments of this disclosure is merely for description, and do not imply the preference among embodiments.

FIG. 16 is a schematic block diagram of a structure of a computer system for an electronic device for implementing an embodiment of this disclosure.

A computer system 1600 of the electronic device shown in FIG. 16 is merely an example, and may not bring any limitation to the functions and use ranges of this embodiment of this disclosure.

As shown in FIG. 16, the computer system 1600 includes a central processing unit (CPU) 1601, which may execute various proper actions and processing based on a program stored in a read-only memory (ROM) 1602 or a program loaded from a storage part 1608 into a random access memory (RAM) 1603. The random access memory 1603 further stores various programs and data required by system operations. The central processing unit 1601, the read-only memory 1602, and the random access memory 1603 are connected to each other through a bus 1604. An input/output interface (that is, an I/O interface) 1605 is also connected to the bus 1604.

The following components are connected to the input/output interface 1605: an input part 1606 including a keyboard, a mouth, and the like; an output part 1607 including, for example, a cathode ray tube (CRT), a liquid crystal display (LCD), and a speaker; a storage part 1608 including a hard disk and the like; and a communication part 1609 including a network interface card such as a local area network card or a modem. The communication part 1609 performs communication processing by using a network such as the Internet. A driver 1610 is also connected to the input/output interface 1605 as needed. A removable medium 1611, such as a magnetic disk, an optical disc, a photomagnetic disk, and a semiconductor memory, is installed on the driver 1610 as needed, so that a computer program read from the removable medium is installed into the storage part 1608 as needed.

Particularly, according to embodiments of this disclosure, the processes described in each method flowchart may be implemented as a computer software program. For example, an embodiment of this disclosure includes a computer program product, the computer program product includes a computer program carried on a computer-readable medium, and the computer program includes program code configured for performing the method shown in the flowchart. In such an embodiment, the computer program may be downloaded and installed from a network by using a communication part 1609, and/or installed from a removable medium 1611. When the computer program is executed by the central processing unit 1601, various functions defined in the system of this disclosure are performed.

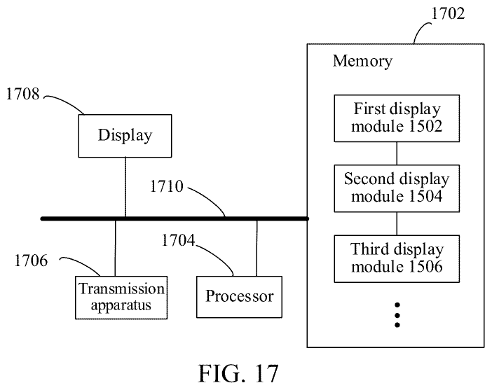

According to another aspect of embodiments of this disclosure, an electronic device for implementing the foregoing virtual object interaction method is further provided. The electronic device may be the terminal device or the server as shown in FIG. 1. In this embodiment, an example in which the electronic device is the terminal device is used for description. As shown in FIG. 17, the electronic device includes a memory 1702 and a processor 1704. The memory 1702 has a computer program stored therein, and the processor 1704 is configured to perform operations in any of the foregoing method embodiments by using the computer program.

In this embodiment, the foregoing electronic device may be located in at least one of a plurality of network devices in a computer network.

In this embodiment, the processor may be configured to perform various methods in the foregoing embodiments by using the computer program.

In one embodiment, a person of ordinary skill in the art may understand that, a structure shown in FIG. 17 is only schematic. The electronic device may alternatively be a terminal device such as a smartphone (such as an Android mobile phone or an iOS mobile phone), a tablet computer, a palmtop computer, a mobile Internet device (MID), or a PAD. FIG. 17 does not constitute a limitation on a structure of the electronic device. For example, the electronic device may further include more or fewer components (for example, a network interface) than those shown in FIG. 17, or has a configuration different from that shown in FIG. 17.

The memory 1702 may be configured to store a software program and a module, such as a program instruction/module corresponding to the virtual object interaction method and apparatus in embodiments of this disclosure. Processing circuitry, such as the processor 1704 runs the software program and the module stored in the memory 1702, to perform various function applications and data processing, in other words, implement the foregoing virtual object interaction method. The memory 1702, such as a non-transitory computer-readable storage medium, may include a high-speed random memory, and may further include a non-volatile memory, for example, one or more magnetic storage apparatuses, a flash memory, or another non-volatile solid-state memory. In some embodiments, the memory 1702 may further include memories remotely disposed relative to the processor 1704, and the remote memories may be connected to a terminal over a network. Examples of the network include, but are not limited to, the Internet, an intranet, a local area network, a mobile communication network, and a combination thereof. The memory 1702 may be specifically, but is not limited to, configured to store information such as an interaction option. In an example, as shown in FIG. 17, the memory 1702 may include, but is not limited to, the first display module 1502, the second display module 1504, and the third display module 1506 in the virtual object interaction apparatus. In addition, the memory may further include, but is not limited to, another module unit in the virtual object interaction apparatus. Details are not described again in this example.

In one embodiment, a transmission apparatus 1706 is configured to receive or transmit data over a network. Specific examples of the foregoing network include a wired network and a wireless network. In an example, the transmission apparatus 1706 includes a network interface controller (NIC). The network interface controller may be connected to another network device and a router by using a network cable, to communicate with the Internet or a local area network. In an example, the transmission apparatus 1706 is a radio frequency (RF) module, which is configured to communicate with the Internet in a wireless manner.

In addition, the electronic device further includes: a display 1708, configured to display the foregoing target interaction information; and a connection bus 1710, configured to connect various module components in the electronic device.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In another embodiment, the foregoing terminal device or server may be a node in a distributed system. The distributed system may be a blockchain system, the blockchain system may be a distributed system formed by connecting a plurality of nodes through network communication. A peer to peer (P2P) network may be formed between the nodes. Any form of a computing device, such as the server, the terminal, and another electronic device, may become a node in the blockchain system by joining the peer-to-peer network.

According to an aspect of this disclosure, a computer-readable storage medium is provided. A processor of a computer device reads computer instructions from the computer-readable storage medium. The processor executes the computer instructions, so that the computer device performs the virtual object interaction method provided in various exemplary implementations of the foregoing virtual object interaction aspect.

In this embodiment, the computer-readable storage medium may be configured to store a computer program configured for performing various method operations in the foregoing embodiments.

In this embodiment, a person of ordinary skill in the art may understand that, all or some operations in the methods of the foregoing embodiments may be performed by a program instructing hardware of the terminal device. The program may be stored in a computer-readable storage medium. The storage medium may include: a flash drive, a read-only memory (ROM), a random access memory (RAM), a magnetic disk, an optical disc, and the like.

The sequence numbers of the foregoing embodiments of this disclosure are merely for description, and do not imply the preference among embodiments.

When the integrated unit in the foregoing embodiments is implemented in the form of a software functional unit and sold or used as an independent product, the integrated unit may be stored in the foregoing computer-readable storage medium. Based on such understanding, the technical solutions of this disclosure, or a part contributing to the related art, or all or a part of the technical solution may be implemented in a form of a software product. The computer software product is stored in a storage medium and includes several instructions for instructing one or more computer devices (which may be a personal computer, a server, a network device, or the like) to perform all or some of operations of the method in embodiments of this disclosure.

In the foregoing embodiments of this disclosure, the descriptions of embodiments have respective focuses. For a part that is not described in detail in an embodiment, refer to related descriptions in other embodiments.

In the several embodiments provided in this disclosure, the disclosed client may be implemented in another manner. The apparatus embodiments described above are merely examples. For example, the division into the units is merely the division of logic functions, and may use other division manners during actual implementation. For example, a plurality of units or components may be combined, or may be integrated into another system, or some features may be ignored or not performed. In addition, the coupling, or direct coupling, or communication connection between the displayed or discussed components may be the indirect coupling or communication connection by using some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of embodiments.

In addition, functional units in embodiments of this disclosure may be integrated into one processing unit, or each of the units may be physically separated, or two or more units may be integrated into one unit. The integrated unit may be implemented in the form of hardware, or may be implemented in the form of a software functional unit.

The foregoing descriptions are merely examples of this disclosure. A person of ordinary skill in the art may further make various improvements and modifications without departing from the principle of this disclosure, and the improvements and modifications are also to be considered as the protection scope of this disclosure.

What is claimed is:

1. A virtual object interaction method, the method comprising:
displaying, by processing circuitry, a first virtual object in a target virtual state in a virtual scene;
displaying a target interaction interface when a first interaction is performed on the first virtual object, the target interaction interface including at least one interaction option corresponding to the target virtual state; and
displaying first target interaction information when a second interaction is performed on a first interaction option of the at least one interaction option, the first target interaction information including an interaction effect associated with the first interaction option for the first virtual object.

2. The method according to claim 1, wherein the displaying the first target interaction information comprises:
displaying the interaction effect of the first virtual object with a first expression based on a first preset probability; and
displaying the interaction effect of the first virtual object with a second expression based on a second preset probability.

3. The method according to claim 2, wherein an interaction effectiveness of the second expression is greater than an interaction effectiveness of the first expression, and the first preset probability is greater than the second preset probability.

4. The method according to claim 2, wherein an interaction effectiveness of the second expression is less than an interaction effectiveness of the first expression, and the first preset probability is greater than the second preset probability.

5. The method according to claim 1, wherein the displaying the first target interaction information comprises:
displaying target text information, the target text information including a text interaction effect associated with the first interaction option for the first virtual object;
displaying target animation information, the target animation information including an animation interaction effect associated with the first interaction option for the first virtual object; or
displaying target sound information, the target sound information including a sound interaction effect associated with the first interaction option for the first virtual object.

6. The method according to claim 1, wherein the method further comprises:
displaying second target interaction information when a third interaction is performed on the first interaction option, the second target interaction information including a different expression of the interaction effect for the first virtual object from the first target interaction information.

7. The method according to claim 6, wherein the displaying the second target interaction information comprises:
displaying a third expression for the first virtual object, and an interaction effectiveness of the third expression being greater than an interaction effectiveness of the first target interaction information; or
displaying a fourth expression for the first virtual object, and an interaction effectiveness of the fourth expression being less than the interaction effectiveness of the first target interaction information.

8. The method according to claim 6, wherein the method further comprises:
displaying third target interaction information when a fourth interaction is performed on the first interaction option, the third target interaction information including a different expression of the interaction effect of the first virtual object from the first target interaction information and the second target interaction information.

9. The method according to claim 6, wherein the second target interaction information is preset based on an account controlling the first virtual object, or an account controlling a second virtual object which interacts with the first virtual object.

10. The method according to claim 1, wherein the first target interaction information is preset based on the target virtual state of the first virtual object, or based on a target virtual state of a second virtual object which interacts with the first virtual object.

11. The method according to claim 1, wherein the method further comprises:
displaying a plurality of virtual objects in the virtual scene, and each virtual object of the plurality of virtual objects being in a preset virtual state; and
acquiring the target virtual state of the first virtual object of the plurality of virtual objects based on the first interaction, and displaying the target interaction interface based on the target virtual state.

12. The method according to claim 1, the method further comprising:
displaying a target prompt message, the target prompt message being configured to prompt a second virtual object to interact with a third virtual object; and
displaying the third virtual object in the virtual scene when a response is triggered on the target prompt message.

13. An information processing apparatus, comprising:
processing circuitry configured to:
display a first virtual object in a target virtual state in a virtual scene;
display a target interaction interface when a first interaction is performed on the first virtual object, the target interaction interface including at least one interaction option corresponding to the target virtual state; and
display first target interaction information when a second interaction is performed on a first interaction option of the at least one interaction option, the first target interaction information including an interaction effect associated with the first interaction option for the first virtual object.

14. The information processing apparatus according to claim 13, wherein the processing circuitry is configured to:
display target text information of the first target interaction information, the target text information including a text interaction effect associated with the first interaction option for the first virtual object;
display target animation information of the first target interaction information, the target animation information including an animation interaction effect associated with the first interaction option for the first virtual object; or
display target sound information of the first target interaction information, the target sound information including a sound interaction effect associated with the first interaction option for the first virtual object.

15. The information processing apparatus according to claim 13, wherein the processing circuitry is configured to:
display second target interaction information when a third interaction is performed on the first interaction option, the second target interaction information including a different expression of the interaction effect for the first virtual object from the first target interaction information.

16. The information processing apparatus according to claim 15, wherein the processing circuitry is configured to:
display a third expression for the first virtual object, and an interaction effectiveness of the third expression being greater than an interaction effectiveness of the first target interaction information; or
display a fourth expression for the first virtual object, and an interaction effectiveness of the fourth expression being less than the interaction effectiveness of the first target interaction information.

17. A non-transitory computer-readable storage medium, storing instructions which when executed by a processor cause the processor to perform:
displaying a first virtual object in a target virtual state in a virtual scene;
displaying a target interaction interface when a first interaction is performed on the first virtual object, the target interaction interface including at least one interaction option corresponding to the target virtual state; and
displaying first target interaction information when a second interaction is performed on a first interaction option of the at least one interaction option, the first target interaction information including an interaction effect associated with the first interaction option for the first virtual object.

18. The non-transitory computer-readable storage medium according to claim 17, wherein the instructions when executed by the processor further cause the processor to perform:
displaying target text information of the first target interaction information, the target text information including a text interaction effect associated with the first interaction option for the first virtual object;
displaying target animation information of the first target interaction information, the target animation information including an animation interaction effect associated with the first interaction option for the first virtual object; or
displaying target sound information of the first target interaction information, the target sound information including a sound interaction effect associated with the first interaction option for the first virtual object.

19. The non-transitory computer-readable storage medium according to claim 17, wherein the instructions when executed by the processor further cause the processor to perform:
displaying second target interaction information when a third interaction is performed on the first interaction option, the second target interaction information including a different expression of the interaction effect for the first virtual object from the first target interaction information.

20. The non-transitory computer-readable storage medium according to claim 19, wherein the instructions when executed by the processor further cause the processor to perform:
displaying a third expression for the first virtual object, and an interaction effectiveness of the third expression being greater than an interaction effectiveness of the first target interaction information; or
displaying a fourth expression for the first virtual object, and an interaction effectiveness of the fourth expression being less than the interaction effectiveness of the first target interaction information.
